(19) United States
(12) Patent Application Publication
(10) Pub. No.: US 2025/0245906 A1
(43) Pub. Date: Jul. 31, 2025

(54) ACCURATE COLOR REPRODUCTION IN COMPUTER-RENDERED HAIR

(71) Applicant: L'Oreal, Paris (FR)

(72) Inventors: Panagiotis-Alexandros Bokaris, Clichy (FR); Robin Kips, Clichy (FR)

(73) Assignee: L'Oreal, Paris (FR)

(21) Appl. No.: 18/702,251

(22) PCT Filed: Oct. 17, 2022
(86) PCT No.: PCT/EP2022/078787

§ 371 Date: Apr. 17, 2024

(30) Foreign Application Priority Data
Oct. 21, 2021 (FR) 2111155

(51) Int. Cl. G06T 15/06; G06T 7/90

(52) U.S. Cl. CPC G06T 15/06; G06T 7/90; G06T 2207/10024; G06T 2207/20084

(57) ABSTRACT

In some embodiments, a computer-implemented method of rendering hair is provided. A computing system obtains a captured image of a hair swatch. The computing system uses an inverse graphics encoder to determine a set of estimated hair parameters based on the captured image. The computing system uses a non-differentiable renderer to generate a rendered image based on the set of estimated hair parameters and a set of scene parameters. The computing system provides the rendered image for display on a display device.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In some embodiments, a computer-implemented method of rendering hair is provided. A computing system obtains a captured image of a hair swatch. The computing system uses an inverse graphics encoder to determine a set of estimated hair parameters based on the captured image. The computing system uses a non-differentiable renderer to generate a rendered image based on the set of estimated hair parameters and a set of scene parameters. The computing system provides the rendered image for display on a display device.

The set of estimated hair parameters may include at least one of one or more dye color values, a dye concentration value, a melanin concentration value, and a eumelanin/pheomelanin ratio value. The set of estimated hair parameters may include at least one heterogeneity hair parameter.

The inverse graphics encoder may include at least one of a fully convolutional neural network and a transformer network. The non-differentiable renderer may include at least one of a ray tracing renderer, a path tracing renderer, a ray casting renderer, and a light transport renderer. The set of scene parameters may indicate at least one of a camera position and a hairstyle. The hairstyle may be a straight hairstyle.

The inverse graphics encoder may be trained by performing actions including determining a set of hair parameters, generating a rendered training image based on the set of hair parameters and a set of training scene parameters using the non-differentiable renderer, determining estimated hair parameters based on the rendered training image using the inverse graphics encoder, determining a gradient of a loss function that compares the estimated hair parameters to the set of hair parameters, and optimizing the inverse graphics encoder based on the gradient of the loss function.

In some embodiments, a computer-implemented of training an inverse graphics encoder for generating sets of estimated hair parameters based on hair images is provided. A computing system determines a set of hair parameters. The computing system generates a rendered training image based on the set of hair parameters and a set of training scene parameters using a non-differentiable renderer. The computing system determines estimated hair parameters based on the rendered training image using an inverse graphics encoder. The computing system determines a gradient of a loss function that compares the estimated hair parameters to the set of hair parameters. The computing system optimizes the inverse graphics encoder based on the gradient of the loss function. The computing system stores the optimized inverse graphics encoder as a trained inverse graphics encoder.

The set of hair parameters may include at least one of one or more dye color values, a dye concentration value, a melanin concentration value, and a eumelanin/pheomelanin ratio value. Determining the set of hair parameters may include randomly sampling values for the set of hair parameters. Determining the set of hair parameters may include selecting hair parameters from a uniform distribution for each hair parameter.

Optimizing the inverse graphics encoder may include repeating the actions of determining the set of hair parameters, generating the rendered training image, determining the estimated hair parameters, and determining the gradient of the loss function for multiple sets of hair parameters. Optimizing the inverse graphics encoder may include using an Adam optimizer. The inverse graphics encoder may include at least one of a fully convolutional neural network and a transformer network.

The computer-implemented method may also include obtaining, by the computing system, a captured image of a hair swatch; using, by the computing system, the trained inverse graphics encoder to determine a set of estimated hair parameters based on the captured image; and using, by the computing system, the non-differentiable renderer to generate a rendered image based on the set of estimated hair parameters and a set of scene parameters.

In some embodiments, a system is provided that includes a camera system and a hair rendering computing system communicatively coupled to the camera system. The hair rendering computing system is configured to perform actions including obtaining, by the hair rendering computing system, a captured image of a hair swatch from the camera system; using, by the hair rendering computing system, an inverse graphics encoder to determine a set of estimated hair parameters based on the captured image; and using, by the hair rendering computing system, a non-differentiable renderer to generate a rendered image based on the set of estimated hair parameters and a set of scene parameters.

The system may also include a camera and at least one lighting source arranged to illuminate the hair swatch. The system may also include a surface holder configured to hold the hair swatch at a fixed location in relation to the camera and the at least one lighting source. The surface holder may have a flat surface or a curved surface.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a schematic illustration of a non-limiting example embodiment of a hair rendering technique according to various aspects of the present disclosure.

FIG. 2 is a schematic illustration of a non-limiting example embodiment of application of the hair rendering technique illustrated in FIG. 1 according to various aspects of the present disclosure.

FIG. 3 is a schematic diagram of a system for rendering color-accurate images of hair according to various aspects of the present disclosure.

FIG. 4 is a schematic diagram that illustrates details of the camera system illustrated in FIG. 3.

FIG. 5 is a block diagram that illustrates aspects of a non-limiting example embodiment of a hair rendering computing system according to various aspects of the present disclosure.

FIG. 6 is a block diagram that illustrates a non-limiting example embodiment of a computing device appropriate for use as a computing device with embodiments of the present disclosure.

FIG. 7 is a schematic drawing that illustrates a training technique for an inverse graphics encoder according to various aspects of the present disclosure.

FIG. 8 is a flowchart that illustrates a method of training an encoder to predict hair parameters according to various aspects of the present disclosure.

FIG. 9 is a schematic drawing that illustrates a technique for using an inverse graphics encoder to estimate hair parameters from a captured image according to various aspects of the present disclosure.

FIG. 10 is a flowchart that illustrates a method of rendering an image of hair having accurate color according to various aspects of the present disclosure.

### DETAILED DESCRIPTION

Realism of computer-rendered hair is desired in numerous applications including but not limited to animation, gaming, special effects and virtual/augmented reality. Hair appearance complexity lies in the geometry and properties of hair fibers and the interaction between them. For at least these reasons, defining and controlling hair appearance is difficult to automate. Accurately reproducing a specific hair color in a rendering environment is a challenging task that often utilizes manual work and expert knowledge in computer graphics to visually tune the result. Many applications could benefit from an automated method for capturing the appearance of a physical hair sample, including but not limited to augmented/virtual reality applications and hair dying development (in which hairstyles may be rendered based on physical samples of dyed hair).

With regard to hair rendering, various scattering models have been proposed in the literature to simulate the way light is reflected from hair fibers offering physically-based realistic results. Different light bounces on the hair fiber, which is usually represented by a cylinder, have an important effect on the hair appearance and thus its realism. Specularities, hair color and hair tone are directly connected with the three scattering components introduced in Marschner et al. 2003. With the recent advances in the parallelization of ray tracing (including OptiX, and Vulkan RT), path-tracing implementations of these models have become more practical, increasing the degree of realism due to global illumination. The control over the appearance of the hair color is based on physical parameters of individual hair fibers, such as natural melanin concentration/ratio or other artificial dye colorants. In order to improve the user friendliness in production, visual attributes such as the albedo have been introduced and implemented in Renderman to favor the artistic expression. However, the tuning of these parameters to match the appearance of a physical hair sample is almost impossible without a psycho-visual match.

Given a natural image, inverse graphics approaches aim to estimate features that are typically used in computer graphics scene representation, such as an HDR environment map or meshes of 3D objects such as faces. This idea has been successfully applied to material capture tasks, accelerating the computer graphics creation pipeline by estimating material parameters from an example image. Inverse graphics models are generally based on a neural network that is trained on synthetic images using a differentiable renderer for supervision. A differentiable encoder is used to generate parameters that are fed into a differentiable decoder to generate rendered images. However, high-quality hair rendering uses path-tracing operations that are not supported by current differentiable renderers, and non-differentiable renderers are used instead. For example, ray-tracing rendering is a priori a non-differentiable operation. The gradients can be estimated approximately but due to the amount of light bounces in hair geometry the implementation of a conventional inverse graphics approach is intractable.

In the present disclosure, a novel method for hair color digitization is introduced. Given a physical hair sample, an automated method is performed to capture the hair color appearance and render it in a synthetic environment automatically. Such a method has direct applications in virtual/augmented reality, as well as hair dying development. Once hair parameters that affect color are determined, scene parameters can be controlled a posteriori in the rendering environment to simulate various hairstyles.

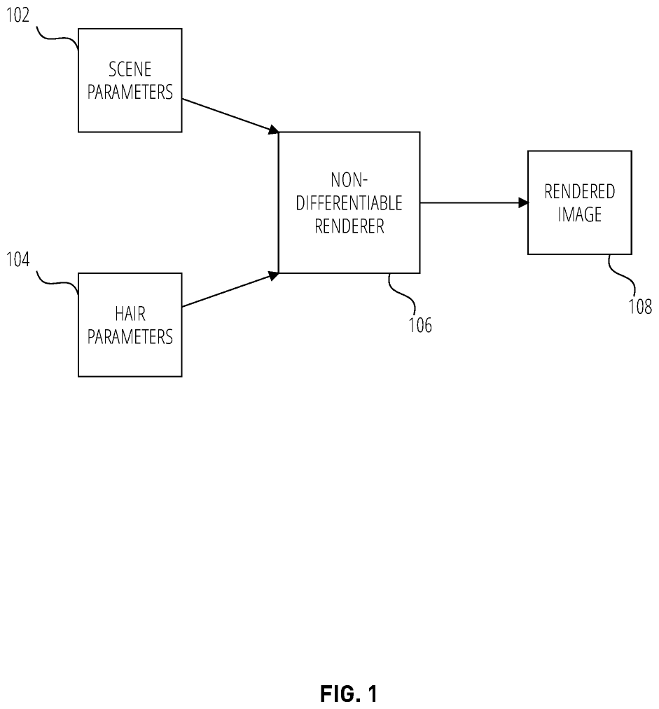

FIG. 1 is a schematic illustration of a non-limiting example embodiment of a hair rendering technique according to various aspects of the present disclosure. In the illustrated technique, the rendering parameters are divided into two categories: hair parameters 104 that determine the hair color and scene parameters 102 which control other aspects of the rendering such as camera position, hairstyle/shape, and lighting conditions.

The scene parameters 102 and the hair parameters 104 are provided as input to a non-differentiable renderer 106, which creates a rendered image 108 based on the scene parameters 102 and the hair parameters 104. In some embodiments, the non-differentiable renderer 106 used may be based on the scattering model described in Pharr 2016 and Yan et al. 2015. Since the objective of this work is hair appearance, a physically based renderer such as a ray tracing renderer that accurately describes the lobes of light bounces on the hair cylinder may be used. The path tracing implementation of the non-differentiable renderer 106 may be performed in a parallelized framework, such as Nvidia OptiX, to accelerate the computations. A ray tracing renderer is a non-limiting example of a non-differentiable renderer. In some embodiments, other types of non-differentiable renderers may be used, including but not limited to path tracing renderers, ray casting renderers, and light transport renderers.

For a given set of hair parameters 104, the scene parameters 102 can be dynamically controlled to produce images at different scales and different hairstyles. The interaction with the non-differentiable renderer 106 for controlling the hair color in the scene is performed by tuning the hair parameters 104, which may include parameters such as the concentration/ratio of the natural hair melanin of individual hair fibers as well as an additional color absorption parameter simulating an artificial dye colorant. In some embodiments, the hair parameters 104 may include parameters for at least one of one or more dye color values (e.g., a value for red, a value for green, and a value for blue; or values for individual components of a different color space); a dye concentration value; a melanin concentration value; and a eumelanin/pheomelanin ratio value. In some embodiments, the hair parameters may include heterogeneity hair parameters that indicate an amount for which a value is allowed to vary over the length of a single strand of hair.

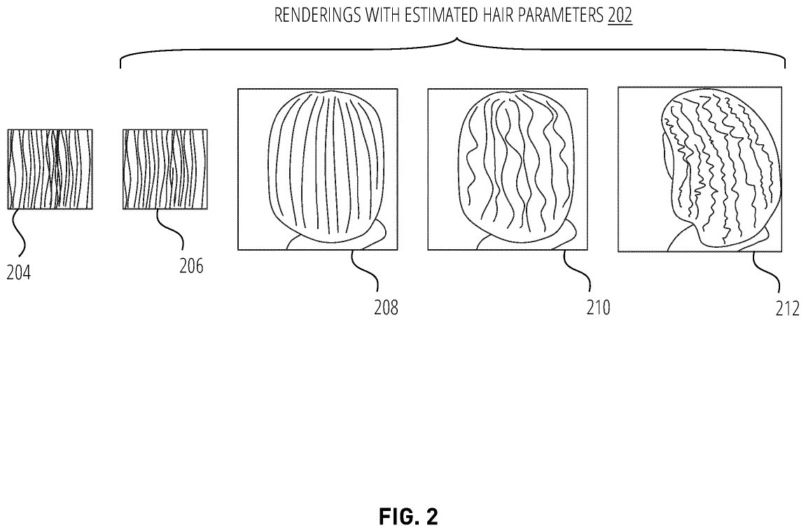

FIG. 2 is a schematic illustration of a non-limiting example embodiment of application of the hair rendering technique illustrated in FIG. 1 according to various aspects of the present disclosure. As shown in FIG. 2, a swatch image 204 is captured, and estimated hair parameters are extracted therefrom. Various different renderings with estimated hair parameters 202 may then be generated by the non-differentiable renderer 106 by providing different scene parameters 102. As shown, a swatch rendering 206 may be generated by using scene parameters 102 that indicate straight hair arranged in the shape of a hair swatch. Other types of scene parameters 102 that indicate different camera positions, hair types, and hairstyle shapes may be used to generate different types of rendered images, including but not limited to a straight hair rendering 208, a wavy hair rendering 210, and a curly hair rendering 212. By extracting the estimated hair parameters from the swatch image 204, each of the renderings with estimated hair parameters 202 accurately reproduce the color of the hair and/or hair dye represented in the swatch image 204.

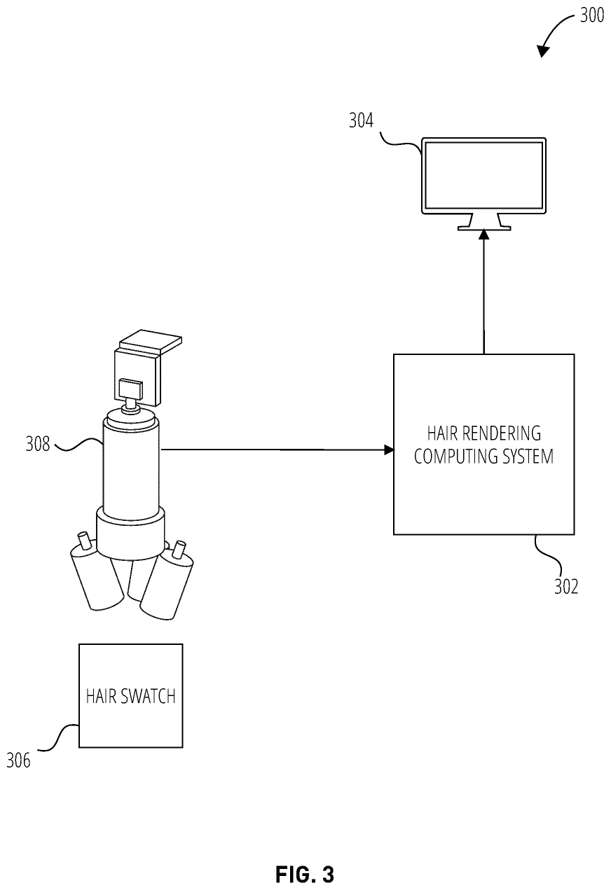

FIG. 3 is a schematic diagram of a system for rendering color-accurate images of hair according to various aspects of the present disclosure. The system 300 includes a hair rendering computing system 302, a camera system 308, and a display device 304. A hair swatch 306 is positioned to be imaged by the camera system 308, and the camera system 308 provides a captured image of the hair swatch 306 to the hair rendering computing system 302. The hair rendering computing system 302 estimates hair parameters based on the captured image of the hair swatch 306, and generates a rendered image to be presented by the display device 304.

In some embodiments, the hair swatch 306 is a physical sample of hair that has been gathered at one or both ends. In some embodiments, the hair swatch 306 may be a sample of natural hair. In some embodiments, the hair swatch 306 may be treated with a dye or other product for which rendered imagery is desired.

In some embodiments, the display device 304 may be any suitable type of device for presenting rendered images, including but not limited to a liquid crystal display (LCD) device. In some embodiments, the display device 304 may be configured to provide one or more color adjustment settings to ensure accurate color reproduction by the display device 304.

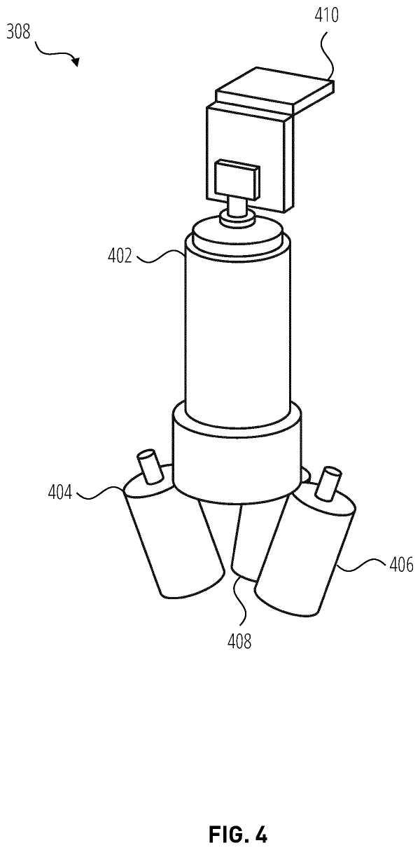

FIG. 4 is a schematic diagram that illustrates details of the camera system illustrated in FIG. 3. As shown, the camera system 308 includes a camera 402, a plurality of lighting sources 404, 406, 408, and a mount 410. The camera 402 may be any suitable type of digital camera and corresponding lenses for capturing digital images of hair swatches 306. The illustrated embodiment includes three lighting sources 404, 406, 408 positioned at different angles in order to ensure thorough illumination of a subject hair swatch 306. In other embodiments, more or fewer lighting sources may be provided. The mount 410 ensures that the camera 402 and the lighting sources 404, 406, 408 are positioned a consistent distance and orientation with respect to the subject hair swatch 306.

Though not illustrated, the camera system 308 may also include a surface holder to position the hair swatch 306 in a predetermined position with respect to the camera system 308 to further ensure this consistency. The surface holder may be configured to position the hair swatch 306 on a flat surface with respect to the camera 402, or may be configured to position the hair swatch 306 on a curved surface with respect to the camera 402 in order to increase the incident angles from which the hair swatch 306 is viewed by the camera 402.

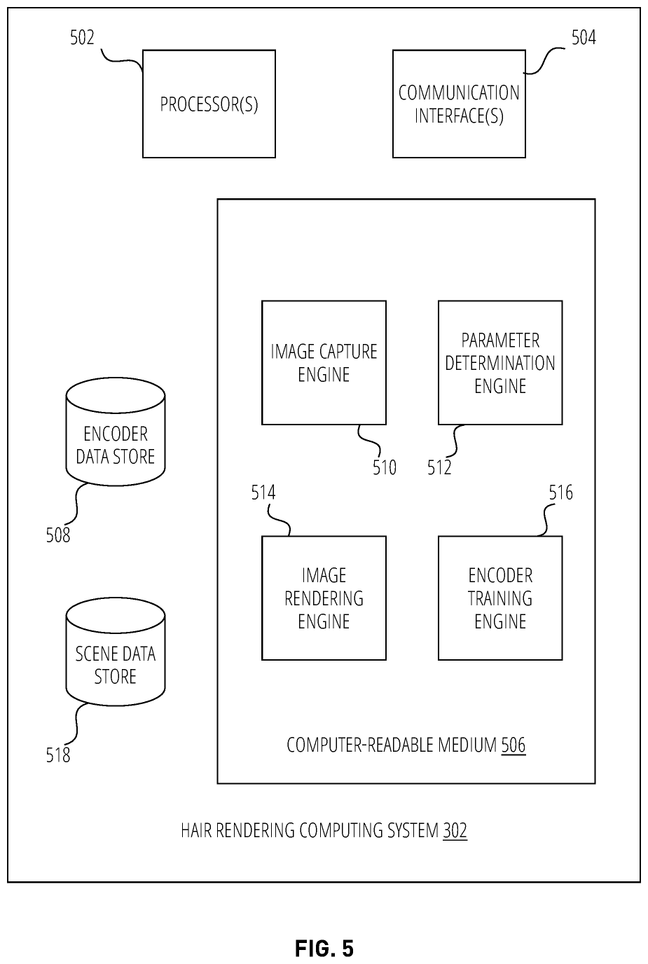

FIG. 5 is a block diagram that illustrates aspects of a non-limiting example embodiment of a hair rendering computing system according to various aspects of the present disclosure. The illustrated hair rendering computing system 302 may be implemented by any computing device or collection of computing devices, including but not limited to a desktop computing device, a laptop computing device, a mobile computing device, a server computing device, a computing device of a cloud computing system, and/or combinations thereof.

As shown, the hair rendering computing system 302 includes one or more processors 502, one or more communication interfaces 504, an encoder data store 508, a scene data store 518, and a computer-readable medium 506.

In some embodiments, the processors 502 may include any suitable type of general-purpose computer processor. In some embodiments, the processors 502 may include one or more special-purpose computer processors or AI accelerators optimized for specific computing tasks, including but not limited to graphical processing units (GPUs), vision processing units (VPTs), and tensor processing units (TPUs).

In some embodiments, the communication interfaces 504 include one or more hardware and or software interfaces suitable for providing communication links between components. The communication interfaces 504 may support one or more wired communication technologies (including but not limited to Ethernet, FireWire, and USB), one or more wireless communication technologies (including but not limited to Wi-Fi, WiMAX, Bluetooth, 2G, 3G, 4G, 5G, and LTE), and/or combinations thereof. The communication interfaces 504 may include one or more interfaces suitable for communication with the camera system 308, and one or more interfaces suitable for communication with the display device 304.

As shown, the computer-readable medium 506 has stored thereon logic that, in response to execution by the one or more processors 502, cause the hair rendering computing system 302 to provide an image capture engine 510, a parameter determination engine 512, an image rendering engine 514, and an encoder training engine 516.

As used herein, “computer-readable medium” refers to a removable or nonremovable device that implements any technology capable of storing information in a volatile or non-volatile manner to be read by a processor of a computing device, including but not limited to: a hard drive; a flash memory; a solid state drive; random-access memory (RAM); read-only memory (ROM); a CD-ROM, a DVD, or other disk storage; a magnetic cassette; a magnetic tape; and a magnetic disk storage.

In some embodiments, the image capture engine 510 is configured to control the camera system 308 to capture images of hair swatches and to receive the captured images from the camera system 308. In some embodiments, the parameter determination engine 512 is configured to estimate hair parameters based on captured images received from the camera system 308 using an inverse graphics encoder stored in the encoder data store 508. In some embodiments, the image rendering engine 514 is configured to use a non-differentiable renderer to generate rendered images based on sets of hair parameters and scene parameters. The hair parameters may be estimated hair parameters from the parameter determination engine 512 or may be hair parameters generated in some other way. The scene parameters may be retrieved from the scene data store 518. In some embodiments, the encoder training engine 516 is configured to train an inverse graphics encoder to estimate hair parameters based on captured images, and to store the trained inverse graphics encoder in the encoder data store 508.

Further description of the configuration of each of these components is provided below

As used herein, “engine” refers to logic embodied in hardware or software instructions, which can be written in one or more programming languages, including but not limited to C, C++, C #, COBOL, JAVA™, PHP, Perl, HTML, CSS, Javascript, VBScript, ASPX, Go, and Python. An engine may be compiled into executable programs or written in interpreted programming languages. Software engines may be callable from other engines or from themselves. Generally, the engines described herein refer to logical modules that can be merged with other engines, or can be divided into sub-engines. The engines can be implemented by logic stored in any type of computer-readable medium or computer storage device and be stored on and executed by one or more general purpose computers, thus creating a special purpose computer configured to provide the engine or the functionality thereof. The engines can be implemented by logic programmed into an application-specific integrated circuit (ASIC), a field-programmable gate array (FPGA), or another hardware device.

As used herein, “data store” refers to any suitable device configured to store data for access by a computing device. One example of a data store is a highly reliable, high-speed relational database management system (DBMS) executing on one or more computing devices and accessible over a high-speed network. Another example of a data store is a key-value store. However, any other suitable storage technique and/or device capable of quickly and reliably providing the stored data in response to queries may be used, and the computing device may be accessible locally instead of over a network, or may be provided as a cloud-based service. A data store may also include data stored in an organized manner on a computer-readable storage medium, such as a hard disk drive, a flash memory, RAM, ROM, or any other type of computer-readable storage medium. One of ordinary skill in the art will recognize that separate data stores described herein may be combined into a single data store, and/or a single data store described herein may be separated into multiple data stores, without departing from the scope of the present disclosure.

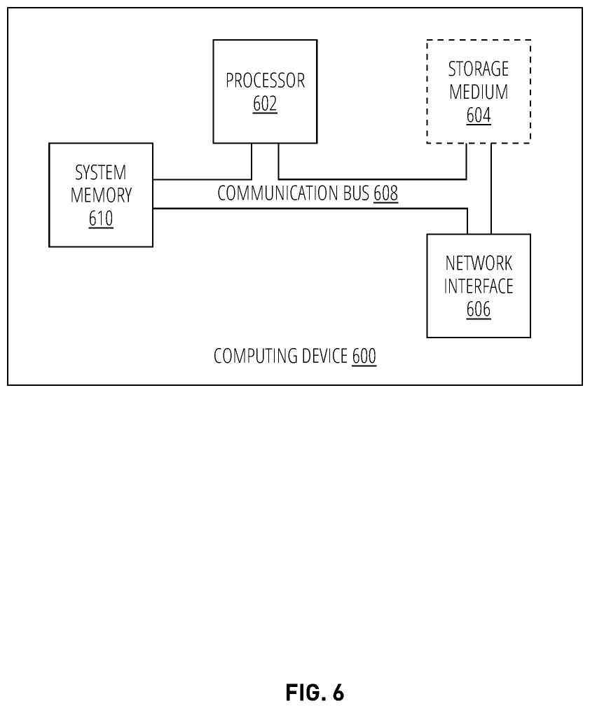

FIG. 6 is a block diagram that illustrates aspects of an example computing device 600 appropriate for use as a computing device of the present disclosure. While multiple different types of computing devices were discussed above, the example computing device 600 describes various elements that are common to many different types of computing devices. While FIG. 6 is described with reference to a computing device that is implemented as a device on a network, the description below is applicable to servers, personal computers, mobile phones, smart phones, tablet computers, embedded computing devices, and other devices that may be used to implement portions of embodiments of the present disclosure. Some embodiments of a computing device may be implemented in or may include an application-specific integrated circuit (ASIC), a field-programmable gate array (FPGA), or other customized device. Moreover, those of ordinary skill in the art and others will recognize that the computing device 600 may be any one of any number of currently available or yet to be developed devices.

In its most basic configuration, the computing device 600 includes at least one processor 602 and a system memory 610 connected by a communication bus 608. Depending on the exact configuration and type of device, the system memory 610 may be volatile or nonvolatile memory, such as read only memory (“ROM”), random access memory (“RAM”), EEPROM, flash memory, or similar memory technology. Those of ordinary skill in the art and others will recognize that system memory 610 typically stores data and/or program modules that are immediately accessible to and/or currently being operated on by the processor 602. In this regard, the processor 602 may serve as a computational center of the computing device 600 by supporting the execution of instructions.

As further illustrated in FIG. 6, the computing device 600 may include a network interface 606 comprising one or more components for communicating with other devices over a network. Embodiments of the present disclosure may access basic services that utilize the network interface 606 to perform communications using common network protocols. The network interface 606 may also include a wireless network interface configured to communicate via one or more wireless communication protocols, such as Wi-Fi, 2G, 3G, LTE, WiMAX, Bluetooth, Bluetooth low energy, and/or the like. As will be appreciated by one of ordinary skill in the art, the network interface 606 illustrated in FIG. 6 may represent one or more wireless interfaces or physical communication interfaces described and illustrated above with respect to particular components of the computing device 600.

In the example embodiment depicted in FIG. 6, the computing device 600 also includes a storage medium 604. However, services may be accessed using a computing device that does not include means for persisting data to a local storage medium. Therefore, the storage medium 604 depicted in FIG. 6 is represented with a dashed line to indicate that the storage medium 604 is optional. In any event, the storage medium 604 may be volatile or nonvolatile, removable or nonremovable, implemented using any technology capable of storing information such as, but not limited to, a hard drive, solid state drive, CD ROM, DVD, or other disk storage, magnetic cassettes, magnetic tape, magnetic disk storage, and/or the like.

Suitable implementations of computing devices that include a processor 602, system memory 610, communication bus 608, storage medium 604, and network interface 606 are known and commercially available. For ease of illustration and because it is not important for an understanding of the claimed subject matter, FIG. 6 does not show some of the typical components of many computing devices. In this regard, the computing device 600 may include input devices, such as a keyboard, keypad, mouse, microphone, touch input device, touch screen, tablet, and/or the like. Such input devices may be coupled to the computing device 600 by wired or wireless connections including RF, infrared, serial, parallel, Bluetooth, Bluetooth low energy, USB, or other suitable connections protocols using wireless or physical connections. Similarly, the computing device 600 may also include output devices such as a display, speakers, printer, etc. Since these devices are well known in the art, they are not illustrated or described further herein.

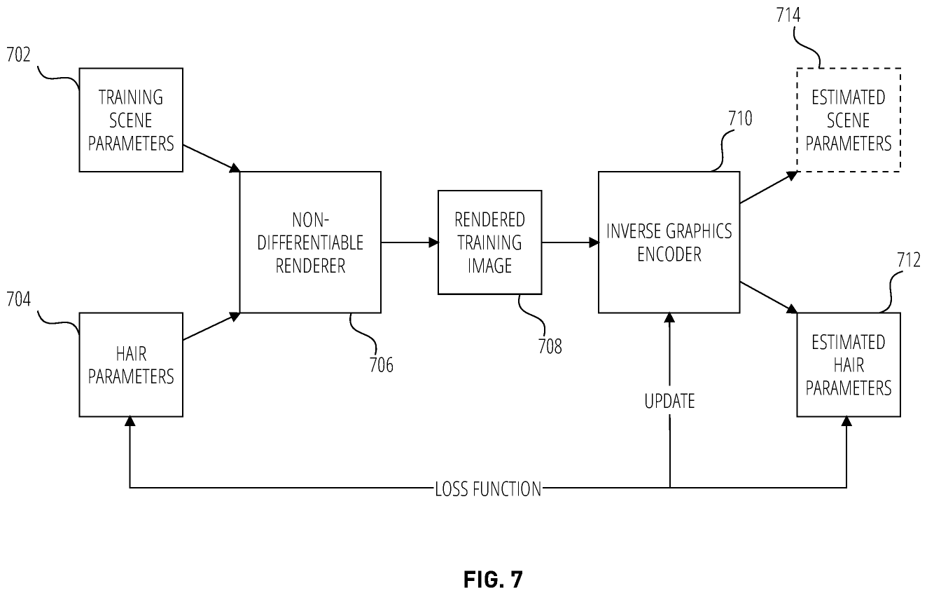

FIG. 7 is a schematic drawing that illustrates a training technique for an inverse graphics encoder according to various aspects of the present disclosure. Training scene parameters 702 and hair parameters 704 are provided to a non-differentiable renderer 706 (such as a renderer based on the scattering model described in Pharr 2016 and Yan et al. 2015) to generate a rendered training image 708.

Typically, the training scene parameters 702 represent a synthetic version of a swatch image, and may include a random camera location with respect to the modeled swatch in order to introduce hair fiber localization variations within the rendered training image 708. The hair parameters 704 may also be a random sample of values for a set of hair parameters. This may lead to the rendered training image 708 including unrealistic hair colors, but ensures that the inverse graphics encoder 710 generalizes well to rare hair colors such as blue or pink.

The rendered training image 708 is then given as input to the inverse graphics encoder 710, which generates estimated hair parameters 712, and optionally generates estimated scene parameters 714. Any suitable inverse graphics encoder may be used as the inverse graphics encoder 710, including but not limited to an encoder implemented using a fully convolutional neural network.

The inverse graphics encoder 710 is trained using gradient descent to minimize a loss function over a plurality of rendered training images 708 generated using a variety of hair parameters 704 and training scene parameters 702. The loss function compares the estimated hair parameters 712 to the actual hair parameters 704 used to generate the rendered training image 708. One non-limiting example of a suitable loss function is:

$${min}_{Θ} {L}_{graphics} = {min}_{Θ} \frac{1}{n} {\sum }_{i = 1}^{n} {‖ {h}_{i} - E ( R ( {h}_{i} , {s}_{i}^{swatch} ) ) ‖}^{2}$$

wherein hᵢ is the set of hair parameters 704, n is the number of sets of hair parameters 704 used, sᵢ^{swatch} is the random training scene parameters 702 for synthesizing the rendered training image 708 represented by R (hᵢ, sᵢ^{swatch}), and E represents the inverse graphics encoder 710 parameterized by its weights Θ.

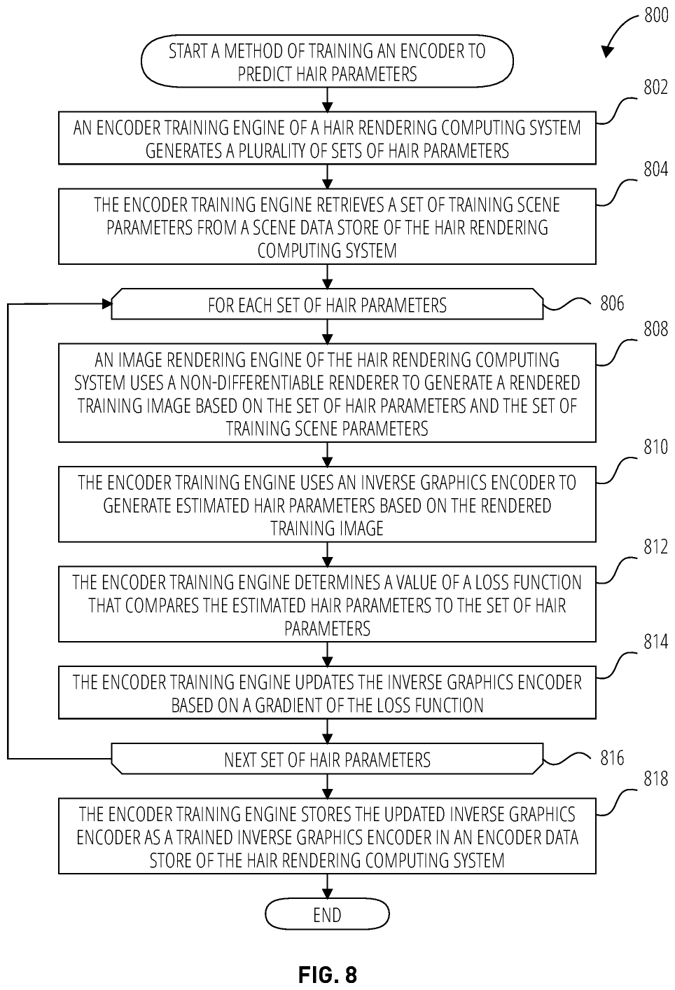

FIG. 8 is a flowchart that illustrates a method of training an encoder to predict hair parameters according to various aspects of the present disclosure. The method 800 is a non-limiting example of an implementation of the training technique illustrated in FIG. 7.

From a start block, the method 800 advances to block 802, where an encoder training engine 516 of a hair rendering computing system 302 generates a plurality of sets of hair parameters. In some embodiments, the values for the sets of hair parameters may be randomly sampled, may be evenly sampled from amongst a valid distribution of values, or may be determined in any other manner.

At block 804, the encoder training engine 516 retrieves a set of training scene parameters from a scene data store 518 of the hair rendering computing system 302. In some embodiments, the set of training scene parameters specify a hairstyle/shape that simulates hair that would be present in a hair swatch, along with camera positions and lighting conditions similar to those provided by the camera system 308. In some embodiments, the hairstyle/shape may simulate a hair swatch, while the camera position and/or lighting conditions may be randomized in polar coordinates in order to generate additional data for training the inverse graphics encoder than would be available with rendered images from a fixed camera location.

The method 800 then advances to a for-loop defined between for-loop start block 806 and for-loop end block 816 wherein each of the sets of hair parameters is used to help train the inverse graphics encoder. From the for-loop start block 806, the method 800 proceeds to block 808, where an image rendering engine 514 of the hair rendering computing system 302 uses a non-differentiable renderer to generate a rendered training image based on the set of hair parameters and the set of training scene parameters.

At block 810, the encoder training engine 516 uses an inverse graphics encoder to generate estimated hair parameters based on the rendered training image. At block 812, the encoder training engine 516 determines a value of a loss function that compares the estimated hair parameters to the set of hair parameters. At block 814, the encoder training engine 516 updates the inverse graphics encoder based on a gradient of the loss function.

The method 800 then proceeds to for-loop end block 816. If further sets of hair parameters remain to be processed, then the method 800 returns to for-loop start block 806 to process the next set of hair parameters. Otherwise, if all of the sets of hair parameters have been processed, then the method 800 advances to block 818.

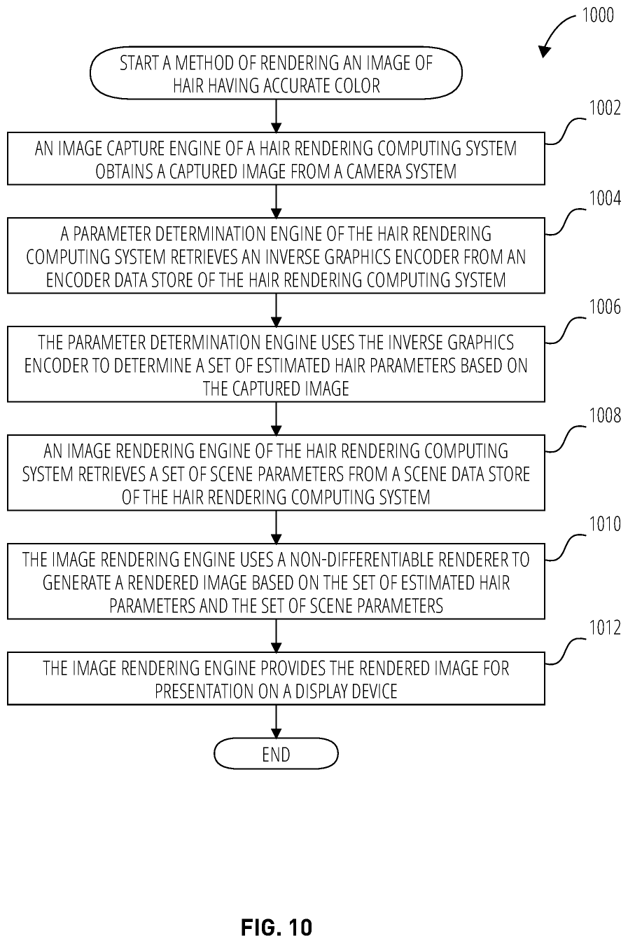

At block 818, the encoder training engine 516 stores the updated inverse graphics encoder as a trained inverse graphics encoder in an encoder data store 508 of the hair rendering computing system 302. The trained inverse graphics encoder may be retrieved later to estimate hair parameters based on newly captured images, such as described below with respect to FIG. 10.

The method 800 then proceeds to an end block and terminates.

Though the method 800 is illustrated as updating the inverse graphics encoder for each set of hair parameters separately, in some embodiments, the method 800 may generate a plurality of rendered training images and determine a plurality of values of the loss function before updating the inverse graphics encoder. Likewise, though the method 800 is illustrated as generating a single rendered training image for each set of hair parameters, in some embodiments, multiple rendered training images using different training scene parameters may be generated for individual sets of hair parameters.

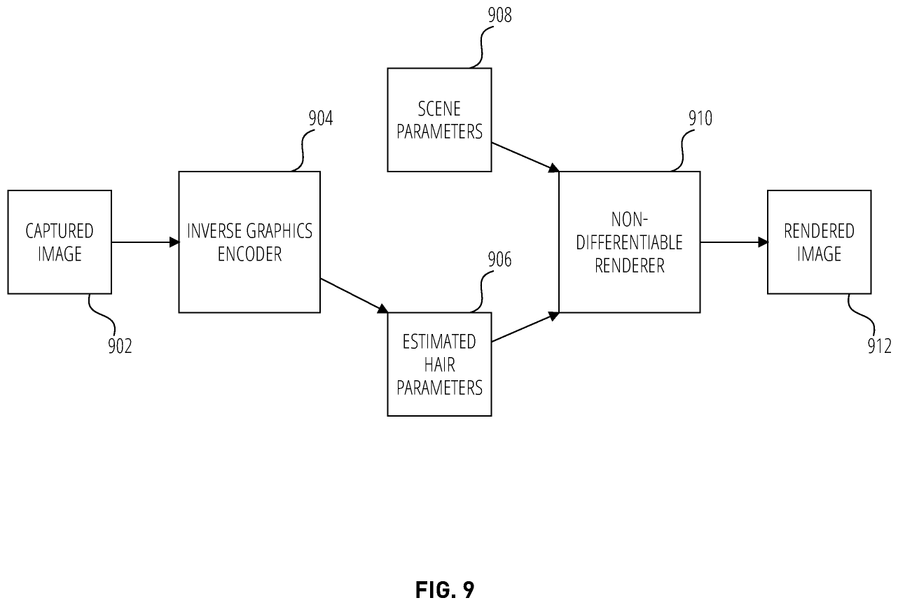

FIG. 9 is a schematic drawing that illustrates a technique for using an inverse graphics encoder to estimate hair parameters from a captured image according to various aspects of the present disclosure.

The camera system 308 is used to capture an image of a hair swatch. The captured image 902 is provided to the inverse graphics encoder 904 which estimates hair parameters that would duplicate the color of the hair in the captured image 902. The estimated hair parameters 906 are provided along with scene parameters 908 that specify a hairstyle, camera position, and, potentially, lighting conditions, to the non-differentiable renderer 910 to generate a rendered image 912.

FIG. 10 is a flowchart that illustrates a method of rendering an image of hair having accurate color according to various aspects of the present disclosure. The method 1000 is a non-limiting example of an implementation of the rendering technique illustrated in FIG. 10.

From a start block, the method 1000 proceeds to block 1002, where an image capture engine 510 of a hair rendering computing system 302 obtains a captured image from a camera system 308. In some embodiments, the image capture engine 510 controls the camera system 308, including but not limited to controlling image capture settings of the camera 402 and settings of the lighting sources 404, 406, 408. In some embodiments, the image capture engine 510 may receive a captured image from the camera system 308 depicting multiple hair swatches, and the image capture engine 510 may segment the captured image to isolate each separate hair swatch to be processed separately.

At block 1004, a parameter determination engine 512 of the hair rendering computing system 302 retrieves an inverse graphics encoder from an encoder data store 508 of the hair rendering computing system 302. At block 1006, the parameter determination engine 512 uses the inverse graphics encoder to determine a set of estimated hair parameters based on the captured image. Since the inverse graphics encoder was trained to estimate hair parameters over a large variety of hair parameters, the estimated hair parameters can be used to generate a color-accurate rendering that simulates the same color as the depicted hair swatch in the captured image.

Accordingly, at block 1008, an image rendering engine 514 of the hair rendering computing system 302 retrieves a set of scene parameters from a scene data store 518 of the hair rendering computing system 302, and at block 1010, the image rendering engine 514 uses a non-differentiable renderer to generate a rendered image based on the set of estimated hair parameters and the set of scene parameters.

At block 1012, the image rendering engine 514 provides the rendered image for presentation on a display device 304. In some embodiments, instead of providing the rendered image for presentation, the image rendering engine 514 may provide the rendered image for storage on a computer-readable medium for later presentation.

The method 1000 then proceeds to an end block and terminates. Though the method 1000 is illustrated as generating a single rendered image, in some embodiments, multiple rendered images based on multiple sets of scene parameters may be generated for a single set of estimated hair parameters determined based on a single captured image. For example, if a hair dye or other product is being developed, a hair swatch may be treated by the product, and a single captured image of the treated hair swatch may be obtained to determine the estimated hair parameters. Then, multiple rendered images may be generated with different hairstyles, different lighting positions, etc., in order to evaluate the quality or suitability of the product.

Performance of a test embodiment of the inverse graphics encoder was analyzed using both qualitative and quantitative methods. In the test embodiment, a training set with 5000 rendered images was used. The inverse graphics encoder was trained over 400 epochs using the Adam optimizer, a fixed learning rate of 10⁻⁶, and a batch size of 32.

For both real and rendered images, it was observed qualitatively that the rendered images accurately capture the hair appearance over a range of various hair colors. The fine color variations between several shades of brown hair were visible in the rendered images, which shows that the test embodiment of the inverse graphics encoder is accurate enough to be used in practice. It was also determined that heterogeneity hair parameters, such as a standard deviation for each hair parameter, would be useful to reproduce the natural hair color variation that can exist within individual hair fibers.

For a quantitative analysis, a set of 300 original hair swatch images were synthesized using random hair parameters drawn according to a uniform distribution. For each synthetic image, the hair parameters were estimated using the test embodiment of the inverse graphics encoder, and the corresponding image was rendered using the same scene parameters to obtain images with aligned hair fibers. Finally, various image reconstruction metrics were computed between the original and reconstructed strand images. The results of this experiment are reported below. The low errors on all image reconstruction metrics tend to confirm the qualitative evaluation results.

| Metric Name | Metric Value (mean +/− std) |
|---|---|
| L1 | 7.08 +/− 11.79 |
| MSSIM [Wang et al. 2003] | 0.20 +/− 0.04 |
| LPIPS [Zhang et al. 2018] | 0.12 +/− 0.19 |

While illustrative embodiments have been illustrated and described, it will be appreciated that various changes can be made therein without departing from the spirit and scope of the invention.

1. A computer-implemented method of rendering hair, the method comprising:
obtaining, by a computing system, a captured image of a hair swatch;
using, by the computing system, an inverse graphics encoder to determine a set of estimated hair parameters based on the captured image;
using, by the computing system, a non-differentiable renderer to generate a rendered image based on the set of estimated hair parameters and a set of scene parameters; and
providing, by the computing system, the rendered image for display on a display device,
wherein the set of estimated hair parameters include at least one of:
one or more dye color values;
a dye concentration value;
a melanin concentration value; and
a eumelanin/pheomelanin ratio value.

2. The computer-implemented method of claim 1, wherein the set of estimated hair parameters include at least one heterogeneity hair parameter.

3. The computer-implemented method of claim 1, wherein the inverse graphics encoder includes at least one of a fully convolutional neural network and a transformer network.

4. The computer-implemented method of claim 1, wherein the non-differentiable renderer includes at least one of a ray tracing renderer, a path tracing renderer, a ray casting renderer, and a light transport renderer.

5. The computer-implemented method of claim 1, wherein the set of scene parameters indicate at least one of a camera position and a hairstyle.

6. The computer-implemented method of claim 5, wherein the hairstyle is a straight hairstyle.

7. The computer-implemented method of claim 1, wherein the inverse graphics encoder is trained by performing actions comprising:
determining a set of hair parameters;
generating a rendered training image based on the set of hair parameters and a set of training scene parameters using the non-differentiable renderer;
determining estimated hair parameters based on the rendered training image using the inverse graphics encoder;
determining a gradient of a loss function that compares the estimated hair parameters to the set of hair parameters; and
optimizing the inverse graphics encoder based on the gradient of the loss function.

8. A computer-implemented of training an inverse graphics encoder for generating sets of estimated hair parameters based on hair images, the method comprising:
determining, by a computing system, a set of hair parameters;
generating, by the computing system, a rendered training image based on the set of hair parameters and a set of training scene parameters using a non-differentiable renderer;
determining, by the computing system, estimated hair parameters based on the rendered training image using an inverse graphics encoder;
determining, by the computing system, a gradient of a loss function that compares the estimated hair parameters to the set of hair parameters;
optimizing, by the computing system, the inverse graphics encoder based on the gradient of the loss function; and
storing, by the computing system, the optimized inverse graphics encoder as a trained inverse graphics encoder,
wherein the set of hair parameters includes at least one of:
one or more dye color values;
a dye concentration value;
a melanin concentration value; and
a eumelanin/pheomelanin ratio value.

9. The computer-implemented of claim 8, wherein determining the set of hair parameters includes randomly sampling values for the set of hair parameters.

10. The computer-implemented of claim 8, wherein determining the set of hair parameters includes selecting hair parameters from a uniform distribution for each hair parameter.

11. The computer-implemented of claim 8, wherein optimizing the inverse graphics encoder includes repeating the actions of determining the set of hair parameters, generating the rendered training image, determining the estimated hair parameters, and determining the gradient of the loss function for multiple sets of hair parameters.

12. The computer-implemented of claim 8, wherein optimizing the inverse graphics encoder includes using an Adam optimizer.

13. The computer-implemented of claim 8, wherein the inverse graphics encoder includes at least one of a fully convolutional neural network and a transformer network.

14. The computer-implemented of claim 8, further comprising:
obtaining, by the computing system, a captured image of a hair swatch;
using, by the computing system, the trained inverse graphics encoder to determine a set of estimated hair parameters based on the captured image; and
using, by the computing system, the non-differentiable renderer to generate a rendered image based on the set of estimated hair parameters and a set of scene parameters.

15. A system, comprising:
a camera system; and
a hair rendering computing system communicatively coupled to the camera system and configured to perform actions including:
obtaining, by the hair rendering computing system, a captured image of a hair swatch from the camera system;
using, by the hair rendering computing system, an inverse graphics encoder to determine a set of estimated hair parameters based on the captured image; and
using, by the hair rendering computing system, a non-differentiable renderer to generate a rendered image based on the set of estimated hair parameters and a set of scene parameters,
wherein the set of hair parameters includes at least one of:
one or more dye color values;
a dye concentration value;
a melanin concentration value; and
a eumelanin/pheomelanin ratio value.

16. The system of claim 15, wherein the camera system includes:
a camera; and
at least one lighting source arranged to illuminate the hair swatch.

17. The system of claim 16, further comprising:
a surface holder configured to hold the hair swatch at a fixed location in relation to the camera and the at least one lighting source.

18. The system of claim 17, wherein the surface holder has a flat surface or a curved surface.

19. The system of claim 15, wherein the inverse graphics encoder includes at least one of a fully convolutional neural network and a transformer network.

20. The system of claim 15, wherein the non-differentiable renderer includes at least one of a ray tracing renderer, a path tracing renderer, a ray casting renderer, and a light transport renderer.
